(19) United States
(12) Patent Application Publication
(10) Pub. No.: US 2013/0281085 A1
(43) Pub. Date: Oct. 24, 2013

(54) Selecting a Subscriber Identity in a User Equipment Device Having Multiple Subscriber Identities

(71) Applicant: APPLE INC., Cupertino, CA (US)

(72) Inventors: Abhishek Sen, San Jose, CA (US); Madhusudan Chaudhary, Campbell, CA (US); Karthik Anantharaman, Sunnyvale, CA (US)

(73) Assignee: APPLE INC., Cupertino, CA (US)

(21) Appl. No.: 13/648,368

(22) Filed: Oct. 10, 2012

Related U.S. Application Data
(60) Provisional application No. 61/637,028, filed on Apr. 23, 2012.

(51) Int. Cl. H04W 48/18; H04W 88/06

(52) U.S. Cl. 455/426.1; 455/552.1

(57) ABSTRACT

Selecting a subscriber identity in a user equipment (UE) device having multiple subscriber identities. Location information may be obtained using a first wireless communication technology. The location information may be provided to a subscriber identity module (SIM) in the UE device. A first subscriber identity may be selected by the SIM based on the location information. The UE device may be registered with a network using a second wireless communication technology. The first subscriber identity may be used to register the UE device with the network.

### PRIORITY CLAIM

The present application claims benefit of priority to U.S. Provisional Application No. 61/637,028 titled “Selecting a Subscriber Identity in a User Equipment Device Having Multiple Subscriber Identities” and filed on Apr. 23, 2012, whose inventors are Abhishek Sen, Madhusudan Chaudhary, and Karthik Anantharaman, and which is hereby incorporated by reference in its entirety as thought fully and completely set forth herein.

### FIELD

The present embodiments relate to the field of wireless communication, and more particularly to a system and method for selecting a subscriber identity in a user equipment (UE) device having multiple subscriber identities.

### DESCRIPTION OF THE RELATED ART

Wireless communication systems are rapidly growing in usage. Further, wireless communication technology has evolved from voice-only communications to also include the transmission of data, such as Internet and multimedia content. Therefore, improvements are desired in wireless communication.

Subscribers in a wireless telecommunication network (e.g., a cellular telecommunication network) are typically assigned subscriber identity information, which may for example be stored as part of a subscriber identity module (SIM) in the subscriber's wireless device. As one example, subscribers in 3GPP (LTE/GSM/UMTS) networks have an International Mobile Subscriber Identity (IMSI) that identifies them in their carrier's network.

For subscribers to roam outside of their home network, their carrier typically must negotiate roaming agreements with other network operators so the visited network recognizes the subscriber's identity and allows roaming to proceed. Negotiating and administering these agreements can be time consuming, and there may be a limit on how many roaming agreements a visiting carrier may choose to support. As a result, emerging or smaller carriers can have difficulty offering extensive roaming coverage.

One possible solution is to use two identities on the SIM. One may be provided by a home carrier and another may be provided by a roaming broker who has roaming agreements with international operators. Switching from one identity to the other may be either user triggered or automatically selected.

Manual triggered subscriber identity switching can be time-consuming and laborious for the user, and may also require a certain level of user education and/or support in order to ensure that the user knows how to switch subscriber identities, and knows which subscriber identity will work in different situations (e.g., locations).

In the case of automatic switching, triggering mechanisms are typically based on the same type of wireless communication with which the wireless device would join the network. For example, some wireless devices might scan, detect a cellular network, and attempt (and fail) to join the cellular network multiple times using a first identity before switching to a second identity. In this case, further time may be required for the wireless device to scan and detect the cellular network using the second identity before finally successfully joining the cellular network. Thus, a significant problem with this approach is that it may inherently require a delay in registering for service with the cellular network. Such delays can be significant and may be problematic for the user of the wireless device. Accordingly, improvements in the field would be desirable.

### SUMMARY

Various embodiments are presented of a system and method for selecting a subscriber identity in a user equipment (UE) device having multiple subscriber identities. In particular, because relying on triggers from within the same wireless communication technology for which the subscriber identity is used can result in significant delays, some embodiments are directed at a system and method for selecting a subscriber identity based on information which is obtained using a different wireless communication technology than the wireless communication technology for which the subscriber identity is used.

For example, UE devices which are capable of communicating using multiple wireless communication technologies may typically have other, potentially faster ways available to them to assist in selection of a subscriber identity. By using such techniques, the processes of identification of and registration with a network using an appropriate subscriber identity may be greatly aided, potentially resulting in a much improved user experience.

Embodiments of the disclosure may thus be directed to such a method, to a UE device configured to implement such a method, and/or to a non-transitory computer accessible memory medium storing program instructions executable by a processor to implement such a method.

The UE device may include one or more antennas for performing wireless communication. The UE device may also include a processor configured to execute program instructions. In addition, the UE device may include a non-transitory computer accessible memory medium, which may store program instructions executable by the UE device.

The UE device may be configured for use with a subscriber identity module (SIM). The SIM may be implemented on a smart card (e.g., as an application executing on a smart card), such as a removable smart card (e.g., the SIM may be removable). The smart card may also be referred to as a SIM card in some embodiments. In some embodiments, the SIM card may be considered part of the UE device, though in other embodiments it may be considered a separate component which interacts with the UE device, even if it is housed within the UE device. Alternatively, the SIM may be implemented in (e.g., non-removable) device memory of the UE device, and/or in an embedded universal integrated circuit card (eUICC), e.g., as an embedded SIM (eSIM), if desired. Thus, the SIM may be coupled to or comprised in the UE device.

The SIM may include multiple subscriber identities. For example, the SIM may include a first subscriber identity for use in a first geographic region (e.g., with a home network of the UE device), and a second subscriber identity for use in a second geographic region (e.g., while roaming). In some embodiments, the first subscriber identity may be provided by a first service provider, while the second subscriber identity may be provided by a second service provider.

In some embodiments, the UE device may be configured to wirelessly communicate using one or more wireless telecommunication technologies. For example, the UE device may be capable of communicating using a 3GPP technology such as GSM, UMTS, or LTE, or a 3GPP2 technology such as cdmaOne or CDMA 2000. The SIM and the subscriber identities stored on the SIM may be configured for use with a wireless telecommunication technology. For example, the UE device may be configured to communicate using a 3GPP technology, and the subscriber identities may be international mobile subscriber identities (IMSIs).

In addition, the UE device may be configured to wirelessly communicate using one or more other wireless communication technologies. For example, the UE device may be capable of communicating using WLAN and/or a global navigational satellite system (GNSS) such as global positioning system (GPS).

The method may be performed as follows.

The UE device may be booted. Location information may be obtained using a first wireless communication technology. The first wireless communication technology may be a non-cellular wireless communication technology, in some embodiments. In some embodiments, the first wireless communication technology may include WLAN. Alternatively, the first wireless communication technology may include a global navigational satellite system.

The location information may, in some embodiments, indicate a geographic region (e.g., a country) in which the UE device is located, or other geospatial information relating to the location of the UE device. The location information may also or alternatively identify a network (e.g., a cellular network), which may be available in the location of the UE device. For example, in some embodiments, the location information may include one or more of a mobile country code (MCC) or a mobile network code (MNC), which may correspond to a geographic region and a network (e.g., a cellular network) respectively.

The location information may be provided to the SIM card (e.g., to the SIM, which may be executing on the SIM card). The location information may be provided to the SIM in the format in which it was obtained using the first wireless communication technology, or may be re-formatted and/or used to determine (e.g., generate) information which is usable by the SIM. For example, the information provided to the SIM may be configured for use by the SIM in selecting a subscriber identity. As one example, the UE device might obtain location information indicating a country in which the UE is currently located using the first wireless communication technology, and determine an MCC corresponding to that country. The MCC might then be provided to the SIM as the location information.

In some embodiments, the UE may generate and provide a command, such as an envelope command, to the SIM. The command may be executable by the SIM. For example, in some embodiments the command may initiate a SIM refresh, which may, for example, cause the SIM to deactivate a previously active subscriber identity and activate a new (“first”) subscriber identity. The newly active first subscriber identity may be selected by the SIM based on the information provided by the UE device, which, as previously described, may be generated based on location information obtained via the first wireless communication technology.

The UE device may register with a network. The UE may register with the network using a second wireless communication technology, which may be a wireless telecommunication (e.g., cellular) technology. For example, the network may be a cellular network. The UE device may register with the network using the active subscriber identity, which may be provided by the SIM.

In some embodiments, at a later time, new location information may be obtained for the UE device. The new location information may be obtained using the first wireless communication technology, or a different (e.g., a third) wireless communication technology. The new location information (or location information generated in a format suitable for use by the SIM based on the new location information) may be provided to the SIM, which may deactivate the previously active first subscriber identity and activate a new (“second”) subscriber identity based on the new location information. The UE device may then register with a new network using the second subscriber identity. The UE device may register with the new network using the second wireless communication technology.

### BRIEF DESCRIPTION OF THE DRAWINGS

A better understanding of the present embodiments can be obtained when the following detailed description of the preferred embodiment is considered in conjunction with the following drawings, in which:

FIG. 1 illustrates an exemplary (and simplified) wireless communication system according to one embodiment;

FIG. 2 illustrates a base station in communication with user equipment according to one embodiment;

FIG. 3 illustrates an exemplary block diagram of a user equipment device, according to one embodiment; and

FIG. 4 is a flowchart diagram illustrating a method for selecting a subscriber identity in a user equipment device having multiple subscriber identities according to one embodiment.

While embodiments described herein susceptible to various modifications and alternative forms, specific embodiments thereof are shown by way of example in the drawings and are herein described in detail. It should be understood, however, that the drawings and detailed description thereto are not intended to limit the embodiments to the particular form disclosed, but on the contrary, the intention is to cover all modifications, equivalents and alternatives falling within the spirit and scope of the present embodiments as defined by the appended claims.

### DETAILED DESCRIPTION OF THE EMBODIMENTS

### Acronyms

The following acronyms are used in the present Provisional patent application.

3GPP: Third Generation Partnership Project

3GPP2: Third Generation Partnership Project 2

MCC: Mobile Country Code

MNC: Mobile Network Code

SIM: Subscriber Identity Module

eSIM: Embedded SIM

UMTS: Universal Mobile Telecommunications System

LTE: Long Term Evolution

GSM: Global System for Mobile Communications

### Terms

The following is a glossary of terms used in the present application:

Memory Medium—Any of various types of memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of memory as well or combinations thereof. In addition, the memory medium may be located in a first computer in which the programs are executed, or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System—any of various types of computing or processing systems, including a personal computer system (PC), mainframe computer system, workstation, network appliance, Internet appliance, personal digital assistant (PDA), personal communication device, smart phone, television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, PDAs, portable Internet devices, music players, data storage devices, or other handheld devices, etc. In general, the term “UE” or “UE device” can be broadly defined to encompass any electronic, computing, and/or telecommunications device (or combination of devices) which is easily transported by a user and capable of wireless communication.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

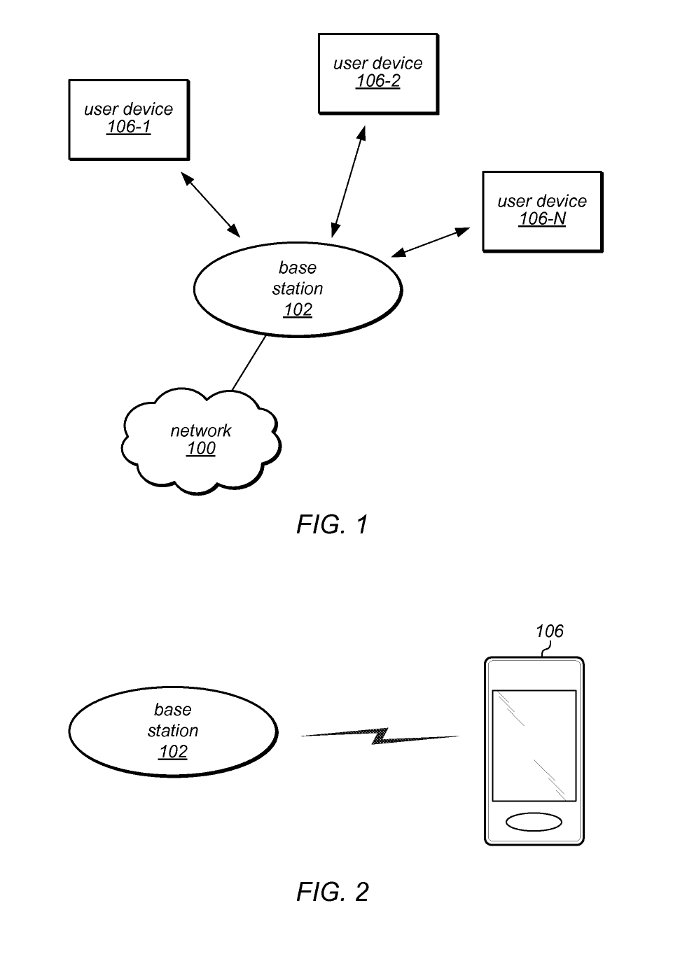

### FIGS. 1-2—Communication System

FIG. 1 illustrates an exemplary (and simplified) wireless communication system. It is noted that the system of FIG. 1 is merely one example of a possible system, and embodiments of the invention may be implemented in any of various systems, as desired.

As shown, the exemplary wireless communication system includes a base station 102 which communicates over a transmission medium with one or more user devices 106-1 through 106-N. Each of the user devices may be referred to herein as a “user equipment” (UE). Thus, the user devices are referred to as UEs or UE devices.

The base station 102 may be a base transceiver station (BTS) or cell site, and comprises hardware that enables wireless communication with the user devices 106-1 through 106-N. The base station 102 may also be equipped to communicate with a network 100. Thus, the base station 102 may facilitate communication between the user devices and/or between the user devices and the network 100.

The base station 102 and the user devices may be configured to communicate over the transmission medium using any of various radio access technologies (RATs), also referred to as wireless communication technologies, or telecommunication standards, such as GSM, CDMA, WLL, WAN, WiFi, WiMAX etc.

At least one UE 106, and possibly each UE 106, may be capable of communicating using multiple wireless communication standards. For example, a UE 106 might be configured to communicate using either or both of a 3GPP telecommunication standard (such as LTE) or a 3GPP2 telecommunication standard (such as CDMA2000). A UE might also or alternatively be configured to communicate using WLAN, Bluetooth, one or more global navigational satellite systems (GNSS, e.g., GPS or GLONASS), one and/or more mobile television broadcasting standards (e.g., ATSC-M/H or DVB-H), etc. Other combinations of wireless communication standards (including more than two telecommunication standards) are also possible.

A UE 106 may thus be able to communicate with base station 102 using a first wireless communication standard, e.g., while in the geographical area served by base station 102. The UE 106 may also be able to communicate with other base stations which utilize the first wireless communication standard, e.g., while in geographical locations served by the other base stations which utilize the first wireless communication standard. For example, the first wireless communication standard may be a cellular wireless communication standard, such as GSM, UMTS, LTE, or CDMA2000 (e.g., a telecommunication standard).

In addition, a UE 106 which is configured to communicate using multiple wireless communication standards may also be able to communicate using a second wireless communication standard which is a non-cellular wireless communication standard. The UE 106 may, for example, use the second wireless communication standard to communicate with access points (e.g., WLAN) or accessory devices (e.g., Bluetooth). The UE 106 may also or alternatively use the second wireless communication standard to receive location, time, elevation, or other information (e.g., GNSS) or broadcast television signals (e.g., ATSC-M/H or DVB-H).

Note that in some cases, a UE 106 may be configured to communicate any number of (e.g., more than two) wireless communication standards, including multiple cellular wireless communication standards (e.g., LTE and CDMA) and/or multiple non-cellular wireless communication standards (e.g., WLAN, GNSS, Bluetooth, and ATSC-M/H).

FIG. 2 illustrates user equipment 106 (e.g., one of the devices 106-1 through 106-N) in communication with the base station 102. The UE 106 may be a device with wireless network connectivity such as a mobile phone, a hand-held device, a computer or a tablet, or virtually any type of wireless device.

The UE may include a processor that is configured to execute program instructions stored in memory. The UE may perform any of the methods embodiments described herein by executing such stored instructions. In some embodiments, the UE may include a programmable hardware element such as an FPGA (field-programmable gate array) that is configured to perform any of the method embodiments described herein, or any portion of any of the method embodiments described herein.

In some embodiments, the UE 106 may be configured to communicate using any of multiple wireless communication protocols. For example, the UE 106 may be configured to communicate using two or more of CDMA 2000, LTE, WLAN, or GNSS. Other combinations of wireless communication standards are also possible.

In some embodiments, the UE 106 may include a plurality of receive antennas and a corresponding plurality of receive chains. The term “receive chain” may refer to a processing path for the received signal. For example, the UE 106 may include separate signal processing chips, each having a respective receive chain, for each of multiple wireless communication protocols. Alternatively (or in addition), multiple wireless communication protocols may share one or more parts of a receive chain in the UE 106 in some embodiments.

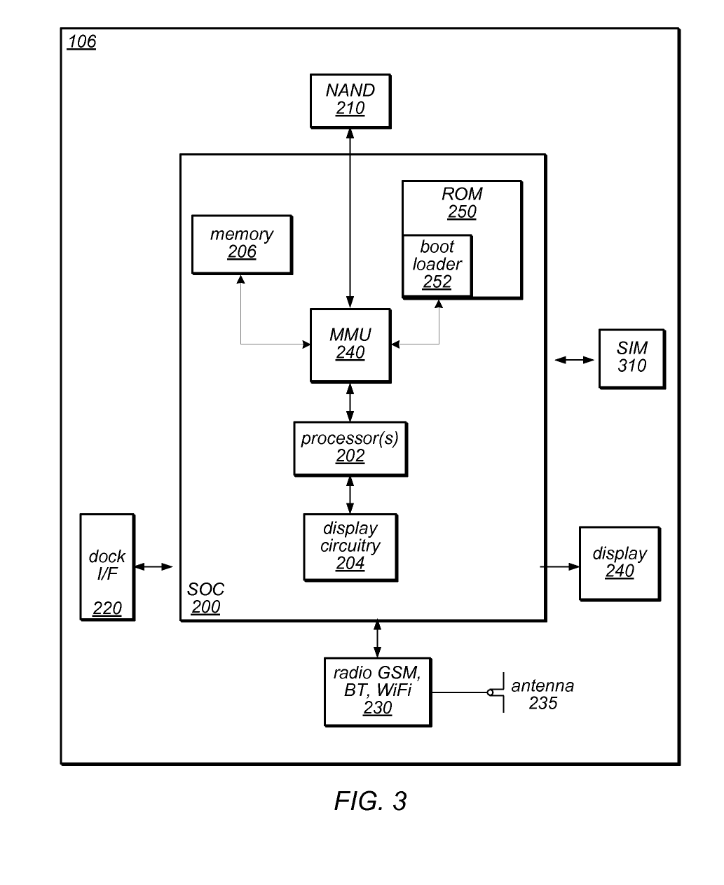

### FIG. 3—Exemplary Block Diagram of a UE

FIG. 3 illustrates an exemplary block diagram of a UE 106. As shown, the UE 106 may include a system on chip (SOC) 200, which may include portions for various purposes. For example, as shown, the SOC 200 may include processor(s) 202 which may execute program instructions for the UE 106 and display circuitry 204 which may perform graphics processing and provide display signals to the display 240. The processor(s) 202 may also be coupled to memory management unit (MMU) 240, which may be configured to receive addresses from the processor(s) 202 and translate those addresses to locations in memory (e.g., memory 206, read only memory (ROM) 250, NAND flash memory 210) and/or to other circuits or devices, such as the display circuitry 204, radio 230, connector I/F 220, and/or display 240. The MMU 240 may be configured to perform memory protection and page table translation or set up. In some embodiments, the MMU 240 may be included as a portion of the processor(s) 202.

In the embodiment shown, ROM 250 may include a bootloader 252, which may be executed by the processor(s) 202 during boot up or initialization. As also shown, the SOC 200 may be coupled to various other circuits of the UE 106. For example, the UE 106 may include various types of memory (e.g., including NAND flash 210), a connector interface 220 (e.g., for coupling to the computer system), the display 240, and wireless communication circuitry (e.g., for LTE, CDMA2000, Bluetooth, WiFi, etc.).

The UE device 106 may include at least one antenna, and in some embodiments multiple antennas, for performing wireless communication with base stations and/or other devices. For example, the UE device 106 may use antenna 235 to perform the wireless communication. The UE may be configured to communicate wirelessly using multiple (e.g., at least two) wireless communication standards. As described herein, the UE 106 may include hardware and software components for operating a UE device which is configured to communicate using multiple wireless communication protocols according to embodiments of this disclosure.

As shown, the UE 106 may include a SIM (Subscriber Identity Module) 310. The SIM may be implemented as an application on a smart card, in some embodiments. The smart card may itself be referred to as a SIM card in some cases. As one example, the SIM 310 may be an application which executes on a Universal Integrated Circuit Card (UICC). The smart card may also include (e.g., store and/or execute) one or more other applications, if desired. The smart card may be removable in some embodiments.

Alternatively, or in addition, in some embodiments the SIM 310 may be implemented as an embedded SIM (eSIM), which may be implemented in a non-volatile memory on the UE device 106, such as memory 206, NAND 210, or another memory medium. For example, the SIM 310 may be an eSIM which is stored on an embedded UICC (eUICC), in some embodiments. Note that in some such embodiments, a memory in which an eSIM is stored may be an integrated/permanent part of the device hardware, and may not be configured for easy installation/removal (e.g., may not be removable), though in such cases it may be possible to re-program or otherwise modify the eSIM functionality without physically removing the memory in which it is stored.

In some embodiments, the SIM 310 may store subscriber identity information. For example, 3GPP carriers typically provide subscribers with an International Mobile Subscriber Identity (IMSI) number which identifies the subscriber to their carrier's network. According to one exemplary embodiment, the IMSI may be a number including the subscriber's “home” mobile country code (MCC) and mobile network code (MNC), as well as a Mobile Subscription Identification Number (MSIN) which is unique to the subscriber. The subscriber identity information may of course take any number of other forms in addition to or instead of the IMSI format.

The subscriber identity information may be used to identify the UE 106 to its subscriber's carrier network. However, in order to use the UE 106 outside of the “home” area in which the subscriber's carrier provides service, the carrier may typically be required to arrange roaming agreements with other network operators, e.g., so that the visited network will recognize the subscriber identity information and allow access to the network.

Negotiating and administering these agreements can be time consuming, and there may be a limit on how many roaming agreements a visiting carrier may choose to support. As a result, emerging or smaller carriers may have difficulty offering extensive roaming coverage.

One possible alternative may include storing subscriber identification information for multiple subscriber identities on the SIM 310. For example, one subscriber identity might be provided by a home carrier while another subscriber identity might be provided by a roaming broker, e.g., who has roaming agreements other networks (e.g., international networks). In some embodiments, the SIM 310 may thus include two subscriber identities, though in other embodiments, the SIM 310 may include three, four, or any number of subscriber identities, e.g., in order to provide greater roaming coverage to a subscriber.

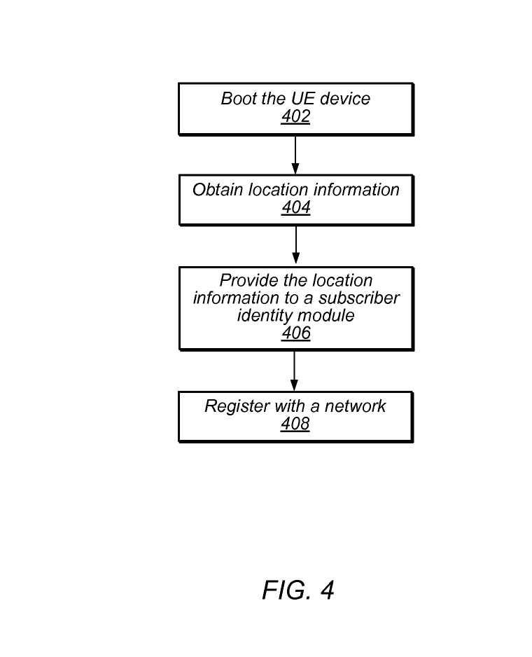

In some embodiments, only one subscriber identity may be active at a time. For example, the SIM 310 may initially select a subscriber identity, which the UE 106 may then utilize in performing wireless communications with base stations (such as base station 102). It may thus be important to provide an effective means of selecting an appropriate subscriber identity in a UE which includes multiple subscriber identities. FIG. 4 and the description provided with respect thereto relate to one such method for selecting a subscriber identity in a UE which includes multiple subscriber identities according to one set of embodiments.

The processor 202 of the UE device 106 may be configured to implement part or all of the methods described herein, e.g., by executing program instructions stored on a memory medium (e.g., a non-transitory computer-readable memory medium). In other embodiments, processor 202 may be configured as a programmable hardware element, such as an FPGA (Field Programmable Gate Array), or as an ASIC (Application Specific Integrated Circuit).

### FIG. 4—Flowchart

FIG. 4 is a flowchart diagram illustrating a method for selecting a subscriber identity in a user equipment (UE) device having multiple subscriber identities according to one set of embodiments.

Some common techniques for managing subscriber identities in UE devices may include manual (user) triggered subscriber identity switching and automatic subscriber identity switching.

Manual triggered subscriber identity switching can be time-consuming and laborious for the user, and may also require a certain level of user education and/or support in order to ensure that the user knows how to switch subscriber identities, and knows which subscriber identity will work in which situation (e.g., location).

Automatic selection of subscriber identities may represent an improvement in user experience if implemented intelligently. However, existing techniques may rely on triggers from within the same wireless communication technology for which the subscriber identity is used, which can result in significant delays. For example, a UE device might at least have to scan and detect a network in order to determine (e.g., based on the identity of the network) to switch subscriber identities, and might in some cases attempt and fail to join the network one or more times before switching subscriber identities.

However, UE devices which are capable of communicating using multiple wireless communication technologies may have other, faster ways available to them to assist in selection of a subscriber identity. By using such techniques, the processes of identification of and registration with a network using an appropriate subscriber identity may be greatly aided, potentially resulting in a much improved user experience.

Thus, the method of FIG. 4 may particularly relate to a system and method for selecting a subscriber identity based on information which is obtained using a different wireless communication technology than the wireless communication technology for which the subscriber identity is used.

The method shown in FIG. 4 may be used in conjunction with any of the systems or devices shown in the above Figures, among other devices. In various embodiments, some of the method elements shown may be performed concurrently, in a different order than shown, or may be omitted. Note also that additional method elements may also be performed as desired.

In 402, the UE device may be booted. The UE device may, for example, have just been powered on by a user, and may perform various system start-up operations. This may include initiating operating system software and radios for one or more wireless communication modules, among other possible start-up operations. The UE device may be configured to perform wireless communication using at least a first wireless communication technology and a second wireless communication technology. The UE device may further be configured to communicate using any number of additional types of wireless communication, as desired.

Embodiments are also considered in which the UE device may be capable of operating in a limited-use mode, such as a so-called “airplane mode”. In such a mode, one or more communication capabilities, such as one or more wireless communication modules, may be powered down or put into a low-power state, while other functionality may remain. Different UE devices may implement such a limited-use mode in different ways; thus some UE devices may disable telecommunication capability while retaining WLAN, GPS, and/or other wireless communication capability in airplane mode, while other UE devices may disable all wireless communication capability in airplane mode. In such embodiments, the UE device may optionally perform some or all of the subsequently described steps of the method while in airplane mode or just after switching out of airplane mode (e.g., and into a fully-functional operational state). In other embodiments, the UE device may perform the subsequently described steps of the method at any time during operation of the UE device.

In 404, location information may be obtained. The location information may be usable in selecting a subscriber identity from multiple possible subscriber identities. The particular nature of the location information may take any of a variety of forms. For example, in one set of embodiments, the location information may relate to the physical location (e.g., a geographic region, country, province/state, city, geospatial coordinates, etc) of the UE device. In some embodiments the location information may include (or may be used to determine) cellular network specific information, such as a mobile country code (MCC) of a region (e.g., country) in which the UE is located. Additional location-related information, such as one or more mobile network codes (MNCs) of networks which may be available in the current location of the UE device, may also or alternatively be included in (or determined from) the location information. Any of a variety of other types of information may also or alternatively serve as the location information.

The location information may be obtained using the first wireless communication technology. In some embodiments, the first wireless communication technology may be a wireless communication standard which is not primarily used for telecommunications. For example, the first wireless communication technology may be an access-point based wireless communication standard, such as WLAN. Alternatively, the first wireless communication technology may be a satellite-based communication standard such as a global navigational satellite system (GNSS), (e.g., global positioning system (GPS) or GLONASS); a terrestrial broadcasting communication standard, such as DVB-H or ATSC-M/H; or a personal-area-network (PAN) wireless communication standard such as Bluetooth, ZigBee, wireless USB, etc., among other possibilities. Note that in some embodiments, the first wireless communication technology may be a wireless telecommunication standard, if desired, and/or may be a wireless communication standard which is not primarily used for telecommunications but which may be capable of use in telecommunications (e.g., WLAN may be used as one stage of a VoIP telecommunication).

Obtaining the location information may be performed during boot-up of the UE device (e.g., shortly after being powered on), in some embodiments. For example, in the course of booting the UE device, it may be useful to initially obtain the location information to assist the SIM to initially select a subscriber identity. This in turn may speed the process of registering with a network using the second wireless communication standard, particularly if information may be obtained using the first wireless communication standard more rapidly than similar or functionally equivalent information can be obtained using the second wireless communication standard.

In addition, or alternatively, the location information may be obtained at any time while the UE device is in airplane mode (e.g., if the first wireless communication standard is not disabled in airplane mode) or during normal operation of the device. For example, in some embodiments, the UE device may be configured to periodically check whether useful location information is available using the first wireless communication standard, and determine whether a substantial change has occurred in the location of the UE device. This might occur, for example, if the UE device were moving overland (e.g., in a car or train) between one region in which one subscriber identity would be appropriate and a different region in which a different subscriber identity would be appropriate.

In one exemplary set of embodiments, the first wireless communication standard may be WLAN, and the location information may be obtained from a WLAN access point (AP) which provides a Wi-Fi network. For example, in some embodiments, an AP may broadcast location information (e.g., in a beacon), which the UE may be able to receive without actually joining the Wi-Fi network. Alternatively, the UE may join the Wi-Fi network provided by the access point and acquire the location information via the Wi-Fi network, or a broader network to which the Wi-Fi network is connected (e.g., the Internet). In some embodiments, the AP may be configured to provide location information which is specifically configured for use by UEs in selecting subscriber identities. For example, in some embodiments, airport APs (or train station APs, or other transit-locale-oriented APs) may provide mobile country code (MCC) and/or mobile network code (MNC) information for the location in which the AP is located.

In another exemplary set of embodiments, the first wireless communication technology may be a GNSS. For example, the UE device may be configured with a GPS module, from which the UE device may be able to determine geospatial coordinates or other location information. In other embodiments, the first wireless communication technology may be a mobile television broadcast standard (e.g., DVB-H, ATSC-M/H, etc.). For example, the UE device may be configured to determine a location of the UE device via information (e.g., station identification information or other configuration information) received from a mobile television broadcaster. Other wireless communication technologies may also or alternatively be used as the first wireless communication technology in other embodiments.

In some embodiments, the information obtained using the first wireless communication technology may be used to determine and/or generate location information which is more directly usable, e.g., by the SIM. For example, in some embodiments, geospatial coordinates obtained via GPS or the name of a city or country obtained via a Wi-Fi AP (e.g., “London Airport”) may not be directly usable by the SIM. In this case the UE device may use a look-up table (e.g., stored in a memory medium in the UE device) and/or other algorithm to convert information obtained via the first wireless communication technology into a form usable by the SIM. As one example, the UE device may determine a MCC and/or MNC corresponding to the location of the UE device based on the information obtained via the first wireless communication technology. Alternatively, the information obtained via the first wireless communication technology may be directly usable by the SIM (e.g., the UE may directly obtain an MCC and MNC via an airport AP which is configured to provide them).

In 406, the location information may be provided to the SIM. The location information may be in a format which is usable by the SIM. For example, as noted above, in some embodiments the location information may include an MCC and MNC for the present location of the UE. Other formats are also possible.

In some embodiments, the UE may generate a command for the SIM, which may include the location information, and provide the command to the SIM. For example, the UE may generate an envelope command (e.g., a location status command) which indicates to the SIM to update its location information. Updating the location information may in turn cause the SIM to perform a SIM refresh operation and select a subscriber identity suitable for the current location based on the location information provided by the UE. Alternatively, or in addition, a custom command (e.g., which may be specifically configured for a particular SIM) may be generated and provided to the SIM. The command may be directly executable by the SIM, or may simply provide information/an indication of the location information to the SIM, based on which the SIM may activate a subscriber identity which is appropriate for a current location of the UE device based on the location information.

In 408, the UE device may register with a network. The UE device may register with the network using the second wireless communication technology. The second wireless communication technology may be a wireless telecommunication standard. For example, the second wireless communication standard may be a standard used to provide a cellular network, e.g., in which multiple cell sites, typically having overlapping communication ranges, are provided to produce one or more continuous regions of wireless service, typically for telecommunication and/or data provision purposes. Thus in some embodiments, the network may be a cellular network. More generally, a wireless telecommunication standard may be any wireless communication standard which may be used for telecommunication. Examples of wireless telecommunication standards may include GSM, UMTS, LTE, cdmaOne, CDMA2000, etc., among other possible wireless telecommunication standards. The second wireless communication technology may be a different technology than the first wireless communication technology.

According to some embodiments, any of a variety of steps may be performed in order to register with the network. For example, the UE device may scan frequencies (e.g., channels) within a certain operating range for networks. Upon discovering a network, the UE device may identify itself to the network (e.g., using the selected subscriber identity) and negotiate for service. Once the network has determined that the subscriber identity is authorized to use the network (which may be determined at least in part based on the active subscriber identity of the UE device), the UE device may be registered and may be given full (or partial, e.g., depending on the roaming agreement) communication (e.g., voice and/or data) capability with the network. Other steps may alternatively or additionally be performed in registering the UE device with the network, depending on the implementation, as will be apparent to those skilled in the art in light of this disclosure.

In some embodiments, some or all of the above-described steps, or variations thereof, may be performed multiple times. For example, at a later time, the UE device may obtain new location information, provide the new location information to the SIM (based on which the SIM may activate a different subscriber identity), and register with a new network using the different subscriber identity.

It should also be noted that in some embodiments, the UE device may be configured to obtain location information using any of multiple different wireless technologies. Thus, at the later time, the new location information might be obtained using a third wireless communication technology. As one example of a situation in which this might occur, location information might be obtained most rapidly using Wi-Fi AP upon arriving in an airport and powering on the UE device, but while travelling overland in a motor vehicle, no Wi-Fi AP might be available, and a GPS receiver in the UE device might instead be used to obtain the location information.

### Exemplary Use Case

As a non-limiting exemplary use case of the above-described systems and methods, consider a UE device which is configured to communicate using both a 3GPP wireless telecommunication standard (e.g., GSM, UMTS, LTE) and WLAN. As a 3GPP device, the UE may include IMSIs as subscriber identities. In this particular example, consider that the UE may have a first IMSI for a domestic service provider and a second IMSI for an international roaming broker.

While the UE is in its “home” region, the first IMSI may be used to connect to the “home” network. However, if a user powers off the UE device in their home region, takes an international flight to a different country, and powers on the UE device upon arriving at their destination, the UE device may not be able to connect to any 3GPP networks using the first IMSI, as the domestic service provider may not have roaming agreements in place with carriers in their new location.

In order to determine that the UE device should switch to the second IMSI based only on the 3GPP wireless telecommunication capability, the UE device might first attempt to scan for service with the first IMSI active. The UE device might detect a 3GPP network and attempt to join the network, but fail, since the first IMSI (whose carrier does not have a roaming agreement with the network) is active and the second IMSI is inactive. After potentially multiple failed attempts to join the network, the SIM may switch to the second IMSI. The UE device may then re-scan for networks in order to detect the 3GPP network again, and eventually successfully join the network. This may be a long process (e.g., 3-5 minutes, in some embodiments, though shorter (e.g., 2-3 minutes) or longer (e.g., 5-10 minutes) time periods are also possible), during which the user of the UE device may not be able to access the full functionality of the UE device.

In contrast, by utilizing a different wireless communication capability, which may have quicker access to information which might be helpful in selecting an IMSI, the process may be considerably faster. For example, many airports may have Wi-Fi (WLAN) networks available. The UE device may thus be able to use Wi-Fi network related or other public information provided by a Wi-Fi access point within range of the UE to determine a location of the UE device. By providing such information to the UE device's SIM, an appropriate IMSI for the location of the UE device may be readily selected, and registration of the UE device with a 3GPP network in the new location may be significantly (e.g., minutes) more rapid than if only the 3GPP telecommunication capability were used to trigger the IMSI switch.

Thus, it may be desirable to provide a system and method for selecting a subscriber identity in a user equipment (UE) device having multiple subscriber identities, in which the subscriber identity is selected based at least in part on information which is obtained using a different wireless communication technology than the wireless communication technology for which the subscriber identity is used.

It should again be emphasized that while this particular scenario may be one exemplary embodiment of the disclosure, other embodiments of the disclosure may be implemented using any of a variety of types of wireless communication technologies, subscriber identity information, location information, etc., and according to numerous variations of the non-limiting exemplary embodiment described in this section.

Embodiments of the present invention may be realized in any of various forms. For example, in some embodiments, the present invention may be realized as a computer-implemented method, a computer-readable memory medium, or a computer system. In other embodiments, the present invention may be realized using one or more custom-designed hardware devices such as ASICs. In other embodiments, the present invention may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a computer system may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The computer system may be realized in any of various forms. For example, the computer system may be a personal computer (in any of its various realizations), a workstation, a computer on a card, an application-specific computer in a box, a server computer, a client computer, a hand-held device, a tablet computer, a wearable computer, etc.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A method for a user equipment (UE) device to select a subscriber identity, wherein the UE device is configured to perform cellular wireless communication and non-cellular wireless communication, the method comprising:
obtaining location information for the UE device, wherein said obtaining is performed using non-cellular wireless communication;
providing the location information to a subscriber identity module (SIM), wherein the SIM is comprised in or coupled to the UE device;
wherein the SIM comprises a plurality of subscriber identities, wherein the SIM is configured to activate a first subscriber identity based on the location information;
registering with a network using the first subscriber identity, wherein said registering is performed using cellular wireless communication.

2. The method of claim 1, wherein the non-cellular wireless communication comprises WLAN communication.

3. The method of claim 1, wherein the non-cellular wireless communication comprises global navigational satellite system communication.

4. The method of claim 1, wherein the location information comprises one or more of a mobile country code (MCC) and a mobile network code (MNC).

5. The method of claim 1,
wherein the location information identifies the network.

6. The method of claim 1,
wherein providing the location information to the SIM comprises providing an envelope command comprising the location information to the SIM.

7. The method of claim 1, further comprising, at a later time:
obtaining new location information for the UE device, wherein said obtaining is performed using non-cellular wireless communication;
providing the new location information to the SIM;
wherein the SIM is configured to deactivate the first subscriber identity and activate a second subscriber identity based on the new location information;
registering with a new network using the second subscriber identity, wherein said registering is performed using cellular wireless communication.

8. A non-transitory computer accessible memory medium comprising program instructions for a user equipment (UE) device to select a subscriber identity, wherein the program instructions are executable by a processor to:
boot the UE device;
obtain location information using a first wireless communication technology;
provide the location information to a subscriber identity module (SIM) card, wherein the SIM card is configured to use multiple subscriber identities, wherein the SIM card is configured to select a first subscriber identity based on the location information;
register the UE device with a network using a second wireless communication technology, wherein the first subscriber identity is used to register the UE device with the network.

9. The memory medium of claim 8,
wherein the second wireless communication technology is a cellular telecommunication technology, wherein the network is a cellular telecommunication network.

10. The memory medium of claim 8,
wherein the first wireless communication technology is a non-cellular wireless communication technology.

11. The memory medium of claim 8, wherein the program instructions are further configured to:
obtain new location information using the first wireless communication technology;
provide the new location information to the SIM card, wherein the SIM card is configured to select a second subscriber identity based on the new location information;
register the UE device with a new network using the second wireless communication technology, wherein the second subscriber identity is used to register the UE device with the new network.

12. The memory medium of claim 8, wherein the program instructions are further configured to:
obtain the location information using a third wireless communication technology.

13. A user equipment (UE) device, wherein the UE device is configured for use with a subscriber identity module (SIM) comprising subscriber identity information for a plurality of subscriber identities, the UE device comprising:
one or more antennas for performing wireless communication;
a processor;
a non-transitory computer accessible memory medium comprising program instructions executable by the processor to:
receive location information via non-cellular wireless communication;
generate information configured for use by the SIM in selecting an active subscriber identity from the plurality of subscriber identities, wherein the information is generated based on the location information;
provide the information to the SIM;
register with a cellular network using subscriber identity information for the active subscriber identity provided by the SIM.

14. The UE device of claim 13,
wherein the plurality of subscriber identities comprise at least a first subscriber identity for use in a first geographic region and a second subscriber identity for use in a second geographic region;
wherein the location information indicates a geographic region in which the UE device is located.

15. The UE device of claim 13, wherein the non-cellular wireless communication comprises one or more of:
WLAN; or
a global navigational satellite system (GNSS).

16. The UE device of claim 13,
wherein the plurality of subscriber identities comprise at least a first international mobile subscriber identity (IMSI) and a second IMSI.

17. The UE device of claim 13,
wherein the information configured for use by the SIM comprises a command, wherein the command is executable by the SIM.

18. The UE device of claim 17,
wherein the command is executable by the SIM to initiate a SIM refresh.

19. The UE device of claim 17,
wherein the command is executable by the SIM to update location information in the SIM.

20. The UE device of claim 13,
wherein the SIM is an application executing on a smart card coupled to the UE device.

21. The UE device of claim 13,
wherein the SIM is an embedded SIM (eSIM) comprised in the UE device.

22. A user equipment (UE) device, the UE device comprising:
a subscriber identity module (SIM) comprising a first international mobile subscriber identity (IMSI) and a second IMSI;
one or more antennas for performing wireless communications;
a processor;
wherein the UE device is configured to:
obtain first location information using a first wireless communication technology;
activate the first IMSI in the SIM based on the first location information;
register with a first network using a second wireless communication technology, wherein the first IMSI is used to identify the UE device to the first network in order to register with the first network;
obtain second location information using the first wireless communication technology;
activate the second IMSI in the SIM based on the second location information;
register with a second network using the second wireless communication technology, wherein the second IMSI is used to identify the UE device to the second network in order to register with the second network.

23. The UE device of claim 22,
wherein the first IMSI is for use with a home network of the UE device, wherein the second IMSI is for use while roaming.

24. The UE device of claim 22,
wherein the first IMSI is provided by a first service provider, wherein the second IMSI is provided by a second service provider.

25. The UE device of claim 22,
wherein the first location information comprises a first mobile country code (MCC) and a first mobile network code (MNC), wherein the first MNC is an MNC associated with the first network.

26. The UE device of claim 22,
wherein the first location information indicates that the UE device is located in a first country, wherein the second location information indicates that the UE device is located in a second country.
